(19) United States
(12) Patent Application Publication
(10) Pub. No.: US 2013/0083633 A1
(43) Pub. Date: Apr. 4, 2013

(54) BARREL SPRING

(71) Applicants: Pascal Winkler, Saint-Blaise (CH); Yvan Teres, Colombier (CH)

(72) Inventors: Pascal Winkler, Saint-Blaise (CH); Yvan Teres, Colombier (CH)

(21) Appl. No.: 13/700,197

(22) PCT Filed: May 23, 2011
(86) PCT No.: PCT/EP11/58380

§ 371 Date: Nov. 27, 2012

(30) Foreign Application Priority Data
May 27, 2010 (EP) 10164172.8

(51) Int. Cl. G04B 1/16; B22D 25/02; F16F 1/10

(52) U.S. Cl. CPC G04B 1/16; F16F 1/10; B22D 25/02
USPC 368/140; 267/156; 164/6

(57) ABSTRACT

A barrel spring (10) for a mechanism driven by a mainspring, in particular for a timepiece, includes a unitary ribbon of metallic glass. The object is to integrate at least one additional function to the spring function, implemented by a functional portion integrated in the spring.

### TECHNICAL FIELD

The present invention relates to the field of mechanisms driven by a mainspring, in particular in the horology field. It more particularly relates to a barrel spring formed from a monolithic ribbon of metallic glass.

In the present application, the term “spring” must be interpreted as a ribbon made from a material having elastic properties and which comprises a fastening portion at each of its ends, allowing the ribbon to store and release mechanical energy.

### BACKGROUND OF THE INVENTION

Known from document CH 698962 is the possibility of making monolithic ribbons intended to be used as barrel springs from metallic glass. The term “metallic glass” refers to an amorphous metal alloy or an amorphous metal, the solid object of which is obtained from the molten alloy. The intrinsic properties of metallic glasses give them very good elastic aptitudes, excellent ductility, great mechanical strength, and optimized fatigue behavior. This type of material is therefore particularly well-suited to applications in barrel springs, in particular for timepieces.

The aforementioned document also proposes a method for producing such a ribbon of metallic glass, in which a strip of metallic glass is given a shape as close as possible to a predetermined shape, using a so-called Planar Flow Casting technique, before relaxing the strip to set its shape by heating it, before ultimately cooling it. It is mentioned that, in an additional step, a slip-spring may be assembled to the last coil of the spring to allow it to be mounted in a barrel drum. The assembly of the inner coil of the blade on the barrel arbor is not mentioned. Another additional step must be applied to the ribbon to allow it to be connected to a barrel arbor. Thus, this document only provides for producing a monolithic ribbon of metallic glass and not, strictly speaking, producing a spring from metallic glass, since fastening portions must be added or formed on the ribbon obtained using the method described in the patent application.

The present invention proposes to go further in the use of metallic glass to produce barrel springs, including in the method to achieve that aim.

### BRIEF DESCRIPTION OF THE INVENTION

In particular, the present invention proposes to produce a barrel spring made from a monolithic ribbon of metallic glass comprising a fastening portion at each of its ends, characterized in that said spring, i.e. the ribbon and the fastening portions situated at the ends thereof, is monolithic and obtained directly by a molding operation.

According to another aspect, the invention relates to a barrel spring formed from a monolithic ribbon of metallic glass, characterized in that the ribbon comprises at least one functional portion integral with the ribbon to perform at least one additional function in addition to the spring function. “Additional function in addition to the spring function” refers to a function other than the storage or release of mechanical energy or the fastening functions of the ribbon, which are considered inherent to the spring function.

Various additional functions may also be produced, as mentioned in the claims. These functions may potentially be combined with one another.

### BRIEF DESCRIPTION OF THE DRAWINGS

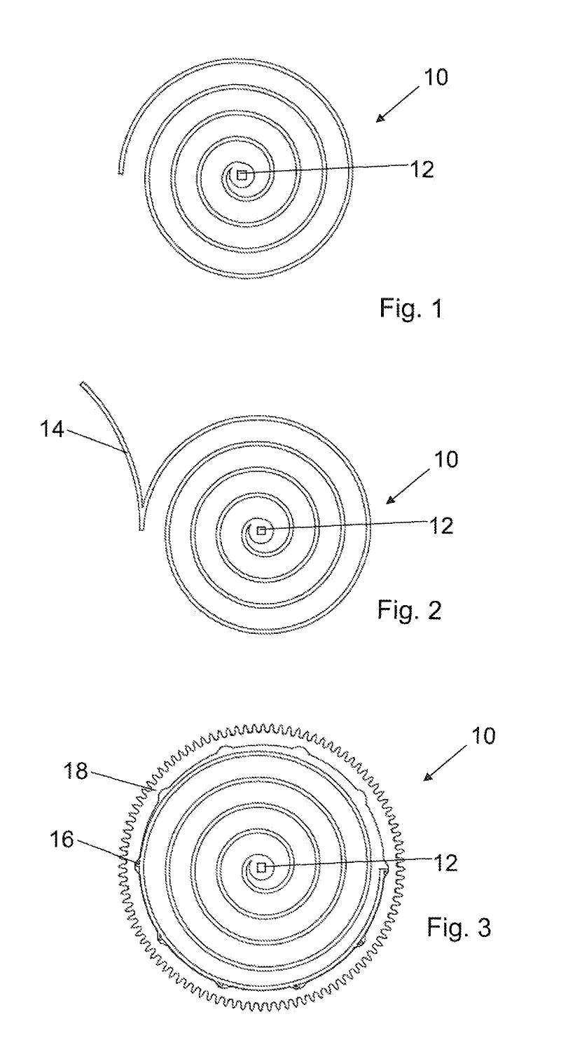

Other details of the invention will appear more clearly upon reading the following description, proposed in reference to the appended drawing, in which FIGS. 1 to 6 illustrate different alternatives of barrel springs according to the invention.

### DETAILED DESCRIPTION OF THE INVENTION

The figures propose barrel springs made from metallic glass. Aside from the normal function of a barrel spring, i.e. the spring function making it possible to store energy owing to a ribbon made from elastic material, the ends of which are provided with fastening portions, the barrel springs according to the invention incorporate an additional function. In other words, in a monolithic embodiment, the barrel springs are configured so as to have a functional portion, making it possible to perform additional function. Thus, “additional function in addition to the spring function” refers to a function other than the energy storage functions, the fastening portions of the ribbon participating in the spring function.

This possibility is in particular offered by a method that is one aspect of the invention. In fact, one of the interesting ideas that made it possible to arrive at the invention is to use a completely different manufacturing method from what is proposed by the state of the art, particularly the aforementioned document, to obtain a barrel spring made from metallic glass.

This method first comprises producing a mold having the shape of the part one wishes to obtain. This mold is advantageously made from silicon using deep etching techniques. The mold thus withstands the melting temperatures of the metallic glasses well, while making it possible to produce complex shapes very precisely. These techniques are well known by those skilled in the art and do not need to be described thoroughly.

Once the mold is obtained, metallic glass can then be poured into the mold, then the glass is cooled so as to preserve an amorphous state, and the part can be stripped. For pouring, the glass may be in the liquid phase or paste phase. The precision of the molds produced means that the obtained parts do not have to be touched up. Furthermore, for stripping, the mold can be dissolved, which allows it to be eliminated, irrespective of the complexity of the part produced, without destroying the latter. It will be noted that the springs could also be molded in a copper mold.

Using this method, it is thus possible to produce various barrel springs 10, incorporating an additional function. First, as particularly shown in FIG. 1, the spring as such is made monolithically. More specifically, the ribbon and the fastening portions situated at each end thereof are thus molded in a single-piece manner. The spring can thus be mounted on the barrel arbor, so as to secure the spring and the arbor in rotation. It is thus possible to eliminate the typical core in the barrel arbor and incorporate that core directly at the center or hub of the spring, said core being made by a non-circular hole 12, for example square, which, through cooperation with an arbor having a corresponding shape, can block the rotation of the spring relative to the arbor.

FIGS. 2 and 3 propose a spring in which the last coil of the spring, aside from the fastening portion it includes, also has an additional function of limiting the winding torque of the barrel. This function is performed by a slip-spring incorporated into the last coil of the spring. In FIG. 2, the spring has a “traditional” slip-spring. The last coil ends with an additional portion 14 extending outward, in the opposite direction from the winding of the balance-spring. The additional portion 14 being made monolithically, and not attached, one thereby avoids an assembly operation. One also avoids any modification of the structure of the material at the connection between the spring and the additional portion, that modification potentially being necessary in particular during a welding operation.

In FIG. 3, the slip-spring is obtained by producing, on the outer perimeter of the last coil, a structure designed to cooperate with a complementary structure of a barrel drum inside which the spring is mounted. In particular, the last coil may have catches 16 designed to cooperate with cavities 18 formed on the inner perimeter of the drum. The cooperation of the catches 16 with the cavities 18 makes it possible to separate the drum and the spring beyond a certain winding torque, defined by the forces exerted between the catches 16 and the cavities 18.

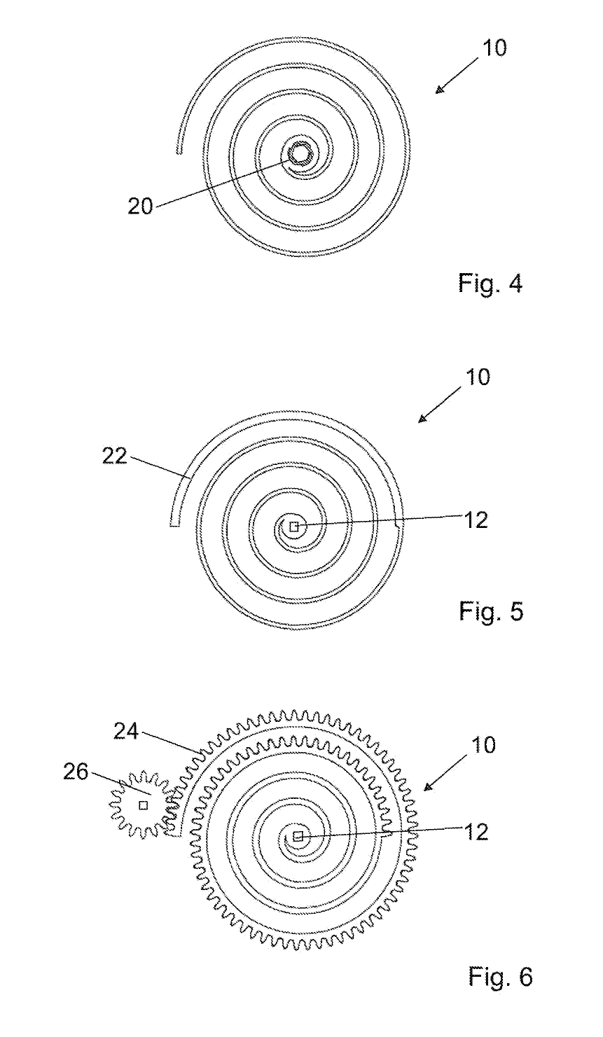

FIG. 4 proposes a unidirectional coupling function making it possible to prevent the spring from being deformed and stressed in the wrong direction of rotation. The hub thus has an adapted structure making it possible to drive the spring when the barrel arbor is driven in one direction, while the connection between the arbor and the spring is uncoupled when the arbor is driven in the other direction. The hub of the spring can thus have notches 20 defining elastic pawls to cooperate with a corresponding structure formed at the arbor. When the arbor pivots in a first direction, it drives the pawls, which rigidly cooperate with it to wind the spring, whereas when the arbor pivots in the other direction, the pawls unclick and the spring is not driven.

The spring illustrated in FIG. 5 performs an additional function that makes it possible to control the eccentricity of the development of the spring, by implementing a portion of the ribbon, for example the last coil, whereof the thickness is variable. By acting on the elastic rigidity of a portion of the strip, it is possible to correct the centering problems observed during the development of a balance spring. It is thus possible, by adjusting the thickness of the last coil of the spring, to ensure that the hub of the spring remains well-centered relative to the barrel, which thereby makes it possible to reduce the stresses exerted on the barrel and the pivots. This makes it possible to reduce the wear of the pivots and the bearings, and, as a result, their dimensions. It is even possible to consider, in this way, eliminating the pivots of the barrel and only keeping one connecting element making it possible to transmit the torque of the spring. It is also possible to produce a last coil having a thicker portion 22 than the rest of the ribbon, so as to limit the winding torque of the barrel.

Lastly, the spring proposed in FIG. 6 has an additional kinematic driving function, implementing a strip portion whereof the outer perimeter defines a toothing 24. This toothing 24 can mesh directly with the train of the watch represented by a wheel 26, which makes it possible to eliminate the drum of the barrel.

As an example, a barrel spring of the type proposed in FIG. 3 has been shown. In this particular case, the coil has a rectangular section with a height of 1 mm and a thickness of 0.25 mm. This example was done by molding a liquid PdCuNiP alloy (T>800K) in a structured silicon mold. After pouring, the molten alloy is then pressed in the mold using a removable piston with a high thermal conductivity, making it possible to evacuate the heat and cool the spring very quickly while preserving the amorphous nature of the material. In another embodiment, the same spring was made using the same method, from an alloy of the ZrCuTiNiAI type. In another example, the molding was done in the paste phase of the alloy in an amorphous state, i.e. at a temperature of the alloy and the mold slightly above the glass transition. In this case, the removable piston is preheated to a temperature of +/−50K around the glass transition temperature of the alloy.

The functions proposed above may in some cases be combined with one another. The figures are only non-limiting examples of the invention, the essence of which is defined in the claims.

1-17. (canceled)

18. A barrel spring for a mechanism driven by a mainspring, in particular for a timepiece, made from a monolithic ribbon of metallic glass comprising a fastening portion for fastening to a barrel drum at a first end, and a fastening portion for fastening to a barrel arbor at a second end, wherein said ribbon and said fastening portions are monolithic and obtained directly by a molding operation.

19. The barrel spring of claim 18, wherein the lower end of the ribbon comprises a fastening portion made up of a non-circular hole arranged along an axis perpendicular to the plane of the spring.

20. The barrel spring of claim 18, wherein the ribbon comprises a clamp integrated into the last coil of the spring.

21. A barrel spring for a mechanism driven by a mainspring, in particular for a timepiece, made from a monolithic ribbon of metallic glass, wherein the ribbon comprises at least one functional part integral with the ribbon to perform at least one additional function in addition to the spring function.

22. The barrel spring of claim 21, wherein said ribbon comprises a fastening portion for fastening to a barrel drum at a first end, and a fastening portion for fastening to a barrel arbor at a second end, and wherein the ribbon and the fastening portions are molded as a single piece.

23. The barrel spring of claim 21, wherein the lower end of the ribbon comprises a fastening portion made up of a non-circular hole arranged along an axis perpendicular to the plane of the spring.

24. The barrel spring of claim 22, wherein the lower end of the ribbon comprises a fastening portion made up of a non-circular hole arranged along an axis perpendicular to the plane of the spring.

25. The barrel spring according to claim 21, wherein the ribbon comprises a clamp integrated into the last coil of the spring.

26. The barrel spring according to claim 21, wherein said additional function is a function limiting the winding torque of the barrel, done by a slip-spring integrated into the last coil of the spring.

27. The barrel spring of claim 26, wherein the last coil ends with an additional portion (14) extending outward.

28. The barrel spring of claim 26, wherein the last coil has a portion that is thicker than the rest of the ribbon.

29. The barrel spring of claim 26, wherein the last coil has a structure on its outer perimeter designed to cooperate with a complementary structure of a barrel drum.

30. The barrel spring of claim 29, wherein the last coil has catches on its outer perimeter that are designed to cooperate with cavities formed on the inner perimeter of a barrel drum.

31. The barrel spring according to claim 21, wherein said additional function is a unidirectional coupling function performed by an adapted structure of the hub of the spring.

32. The barrel spring of claim 31, wherein the hub of the spring includes notches defining elastic pawls.

33. The barrel spring according to claim 21, wherein said additional function is a function for centering the development of the spring, implementing a strip portion having a variable thickness.

34. The barrel spring according to claim 21 wherein said additional function is a kinematic driving function, implementing a strip portion whereof the outer perimeter defines a toothing.

35. A method for producing a spring according to claim 21, comprising the following steps:
making a mold in the form of the spring one wishes to obtain,
pouring metallic glass into the mold,
cooling the glass, and
stripping the spring.

36. The method of claim 35 wherein, after pouring, the spring is pressed in the mold.

37. The method according to claim 35, wherein said mold is made from silicon using deep etching techniques.

38. A barrel comprising a barrel arbor and a drum, as well as a barrel spring housed in the drum, said barrel spring being made from a monolithic ribbon of metallic glass comprising a fastening portion for fastening to a barrel drum at a first end, and a fastening portion for fastening to a barrel arbor at a second end, wherein said ribbon and said fastening portions are monolithic and obtained directly through a molding operation.
